(19) United States
(12) Patent Application Publication
(10) Pub. No.: US 2025/0139501 A1
(43) Pub. Date: May 1, 2025

(54) REDUCING CARBON FOOTPRINT OF MACHINE LEARNING MODELS

(71) Applicant: Mind Foundry Ltd, Oxford (GB)

(72) Inventors: Alessandra Tosi, Cambridge (GB); Robert Bell, Moreton-in-Marsh (GB); Nathaniel Korda, Oxford (GB); Joanna Crown, Oxford (GB); Davide Zilli, Oxford (GB); Brian Mullins, Oxford (GB); Michael Osborne, Oxford (GB); Stephen Roberts, Shipton-on-Cherwell (GB); Alistair Garfoot, Oxford (GB)

(21) Appl. No.: 18/497,400

(22) Filed: Oct. 30, 2023

(51) Int. Cl. G06N 20/00

(52) U.S. Cl. CPC G06N 20/00

(57) ABSTRACT

A machine learning platform operating at a server is described. The machine learning platform accesses a dataset from a datastore. A task that identifies a target of a machine learning algorithm from the machine learning platform is defined. The machine learning algorithm forms a machine learning model based on the dataset and the task. The machine learning platform deploys the machine learning model and monitors a performance of the machine learning model after deployment. The machine learning platform updates the machine learning model based on the monitoring.

### TECHNICAL FIELD

The subject matter disclosed herein generally relates to methods, systems, and programs for a machine learning platform. Specifically, the present disclosure addresses systems, methods, and computer programs for reducing the carbon footprint of machine learning models.

### BACKGROUND

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data. However, operating machine learning tools can be resource intensive and contribute to carbon emission.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 illustrates a carbon footprint reduction application in accordance with one example embodiment.

FIG. 3 illustrates a carbon footprint reduction application in accordance with one example embodiment.

FIG. 4 illustrates a machine learning platform in accordance with one example embodiment.

FIG. 5 illustrates a machine learning platform in accordance with one example embodiment.

FIG. 6 illustrates a machine learning platform in accordance with one example embodiment.

FIG. 7 illustrates a model trainer in accordance with one example embodiment.

FIG. 8 illustrates a model optimization system in accordance with one example embodiment.

FIG. 9 illustrates a method for training a model in accordance with one example embodiment.

FIG. 10 illustrates a routine 1000 in accordance with one embodiment.

FIG. 11 is block diagram showing a software architecture within which the present disclosure may be implemented, according to an example embodiment.

FIG. 12 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural Components, such as modules) are optional and may be combined or subdivided, and operations (e.g., in a procedure, algorithm, or other function) may vary in sequence or be combined or subdivided.

It is desirable to minimize the use of computational resources without compromising the accuracy of their solutions. As an example, data scientists want to know if running other 10x iterations of an optimizer will result in 10x higher accuracy or just in some very negligible accuracy increase. As such, data scientists want to avoid wasting computational resources (memory and time) while prototyping AI solutions. They want, as an example, to avoid launching experiments that will fail because they hit memory limits. However, profiling and monitoring an AI solution can be challenging because breaking down the computational cost between different stages (data ingestion, model training, model deployment) is difficult.

Building a bespoke ML solution is often an iterative process where the data scientist wishes to quickly assess many different approaches and develop only the most promising solutions. Determining an efficient strategy for assessing each solution is challenging for two reasons:
How much data is required to assess a solution? Too much data leads to overly expensive calculations; too little data leads to inconclusive answers.
Are there sufficient resources (e.g. time, memory) to perform this calculation? Often, the resource budgets are often not considered until it is found there is insufficient memory, or the calculation is taking too long. At which point the calculation is abandoned, thus wasting resources spent so far.

The present application describes a system that enables the data scientist to focus on how to solve the problem, and not need to focus on the practicalities of running the solution (including budgeting for limited memory, time or other resources). In one example user workflow, the data scientist (1) constructs a candidate solution for their problem, (2) specifies a maximum time and resources that the solution can use, (3) requests a machine learning platform to train the solution (the machine learning platform automatically selects an appropriate strategy for training the solution within the resource constraints, for example, by automatically downsampling the data, or adjusting model convergence thresholds), and (4) receives their model within the resource budget.

The present application describes a carbon footprint reduction application for a machine learning platform. The carbon footprint reduction application determines a training strategy to configure an underlying model and select how much training data to use. The machine learning platform trains a machine learning model based on the underlying model and the selected training data. The carbon footprint reduction application monitors actual resources used during training of the machine learning model.

In one example embodiment, a computer-implemented method includes accessing training data, a computing resource limit setting, and parameters of a machine learning model, forming, at a server, a machine learning training strategy based on the training data and the computing resource limit setting, forming a machine learning model configuration based on the machine learning training strategy, selecting sampled data from the training data based on the machine learning training strategy, and providing the machine learning model configuration and the sampled data to a machine learning platform.

In another example embodiment, a computer-implemented method includes receiving a machine learning model and a dataset, predicting a resource usage for training the machine learning model on the dataset using a gradient boosted regression tree model, generating candidate training configurations with varying hyperparameters, datasets, and hardware allocations, predicting a resource usage for each candidate configuration using a Gaussian process regression model, selecting a configuration to minimize resource usage and carbon footprint while maintaining a user specified minimum accuracy level, training the machine learning model using the selected configuration, deploying the trained model, monitoring resource usage and carbon footprint during training and deployment, and using the monitored data to retrain the resource forecasting and optimization models.

As a result, one or more of the methodologies described herein facilitate solving the technical problem of training machine learning models with limited resources. As such, one or more of the methodologies described herein may obviate a need for certain efforts or computing resources that otherwise would be involved in using machine learning platforms. As a result, resources used by one or more machines, databases, or devices (e.g., within the environment) may be reduced. Examples of such computing resources include Processor cycles, network traffic, memory usage, data storage capacity, power consumption, network bandwidth, and cooling capacity.

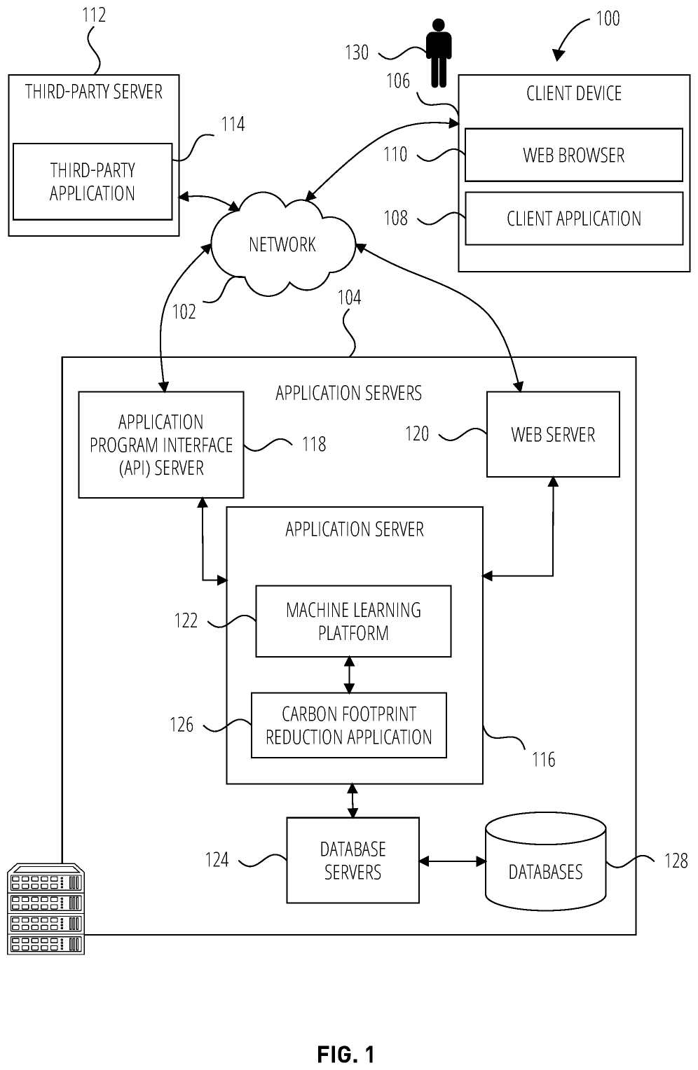

FIG. 1 is a diagrammatic representation of a network environment 100 in which some example embodiments of the present disclosure may be implemented or deployed. One or more application servers 104 provide server-side functionality via a network 102 to a networked user device, in the form of a client device 106. A web browser 110 (e.g., a browser) and a client application 108 (e.g., an “app”) are hosted and execute on the web browser 110. A user 130 operates client device 106.

An Application Program Interface (API) server 118 and a web server 120 provide respective programmatic and web interfaces to application servers 104. A specific application server 116 hosts a machine learning platform 122 (which includes Components, modules and/or applications) and a carbon footprint reduction application 126.

The machine learning platform 122 receives training data from the client device 106, the third-party server 112, and/or the carbon footprint reduction application 126. The machine learning platform 122 generates a machine learning model based on the training data. The machine learning platform 122 deploys the machine learning model and monitors a performance (e.g., accuracy) of the machine learning model. In some example embodiments, the machine learning platform 122 includes machine-learning programs (MLPs), also referred to as machine-learning algorithms or tools, that are utilized to perform operations associated with predicting a value of an item at a future point in time, solving values of a target column, or discovering features of training data.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a machine learning model from training data in order to make data-driven predictions or decisions expressed as outputs. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying attributes of the training data or identifying patterns in the training data.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, machine learning algorithms identify patterns of significance in relation to other attributes in the training data. These algorithms utilize this training data to model such similar relations that might affect a predictive outcome.

The carbon footprint reduction application 126 includes a programmatic application accessed by the client device 106. Example of programmatic applications include a data scientist portal application, a machine learning portal application, and analysis applications. In one example embodiment, the carbon footprint reduction application 126 is external to the machine learning platform 122. In another example embodiment, the machine learning platform 122 is part of the carbon footprint reduction application 126. The carbon footprint reduction application 126 determines a machine learning training strategy that is used to configure an underlying learning model and to select how much training data to use. The carbon footprint reduction application 126 provides the underlying model and the selected training data to the machine learning platform 122. The machine learning platform 122 trains a machine learning model based on the underlying model and the selected training data. The carbon footprint reduction application 126 monitors actual resources used by the machine learning platform 122 during training of the machine learning model.

To optimize machine learning resource usage and carbon footprint, the carbon footprint reduction application 126 employs regression-based models for forecasting and optimization.

For forecasting resource usage, gradient boosted regression trees are utilized. This model type is selected due to its ability to capture complex nonlinear relationships in the data. The gradient boosted models are trained on datasets containing features such as data characteristics (e.g. number of samples, features), model hyperparameters, and hardware specifications as predictors. The target variable is the measured resource usage like training time, memory, or inference latency. Separate models are trained for forecasting resource usage during training versus inference.

For optimizing configurations, a Bayesian hyperparameter optimization technique is implemented. This allows intelligently exploring the space of possible configurations to find those expected to minimize resource usage and carbon footprint. The Bayesian optimizer uses Gaussian process regression models internally to predict resource usage and carbon emissions for untested configurations. Active learning methods are employed, iteratively retraining the models on new data from tested configurations.

The optimization algorithm also utilizes multi-objective Pareto optimization to balance model accuracy versus efficiency. The model accuracy objectives are provided by the user based on their needs. Objectives are combined using a weighted formula where the user can tune the weights. This allows customizing the accuracy-efficiency tradeoff.

The described regression techniques provide tailored resource usage and carbon footprint forecasts. The Bayesian optimization approach leverages these predictions to efficiently navigate the configuration space. Together, these algorithms enable optimizing machine learning resource usage for a given use case.

The following is an example of how a user could interact with the carbon footprint reduction application 126 and customize the configurations:

The user 130 uploads a dataset and specifies the desired machine learning task (e.g. image classification, text generation). The user 130 inputs high-level accuracy goals for the model (e.g. 95% accuracy on a validation dataset). The user 130 specifies a cost/carbon budget for training the model. The user 130 selects optimization criteria like minimizing training time, cost, or carbon footprint. The machine learning platform 122/carbon footprint reduction application 126 trains multiple models with different algorithms, hyperparameters, and hardware to recommend an optimized configuration. The user 130 can accept the recommended configuration or further customize it, like requesting a different model architecture or restricting the geographic region for training. During training, the user 130 can monitor dashboards tracking resource utilization, costs, and carbon footprint. For deployment, the user 130 specifies traffic forecasts and cost/carbon constraints. The carbon footprint reduction application 126 optimizes deployment configurations accordingly. The user 130 customizes tradeoffs between accuracy, cost, and carbon footprint by adjusting weights. More weight on accuracy leads to less optimization. For low-powered edge devices, the user 130 constrains the model size. The carbon footprint reduction application 126 prunes models to fit the memory budget. The user 130 configures automated actions like stopping training or deployment if costs exceed thresholds. In summary, the carbon footprint reduction application 126 provides default optimizations but allows users to customize configurations based on their specific needs and constraints. The goal is to balance accuracy, costs, and carbon footprint.

The web browser 110 communicates with the machine learning platform 122 and/or the carbon footprint reduction application 126 via the web interface supported by the web server 120. Similarly, the client application 108 communicates with the machine learning platform 122 and/or the carbon footprint reduction application 126 via the programmatic interface provided by the Application Program Interface (API) server 118.

The application server 116 is shown to be communicatively coupled to database servers 124 that facilitates access to an information storage repository or databases 128. In an example embodiment, the databases 128 includes storage devices that store information (e.g., training dataset, resource limits configuration, model hyper-parameters, underlying models, augmented dataset, dataset marketplace, machine learning models) to be processed by the machine learning platform 122 and/or the carbon footprint reduction application 126.

Additionally, a third-party application 114 executing on a third-party server 112, is shown as having programmatic access to the application server 116 via the programmatic interface provided by the Application Program Interface (API) server 118. For example, the third-party application 114, using information retrieved from the application server 116, may support one or more features or functions on a website hosted by the third party. For example, the third-party application 114 provides training functionalities/operations for the the machine learning platform 122.

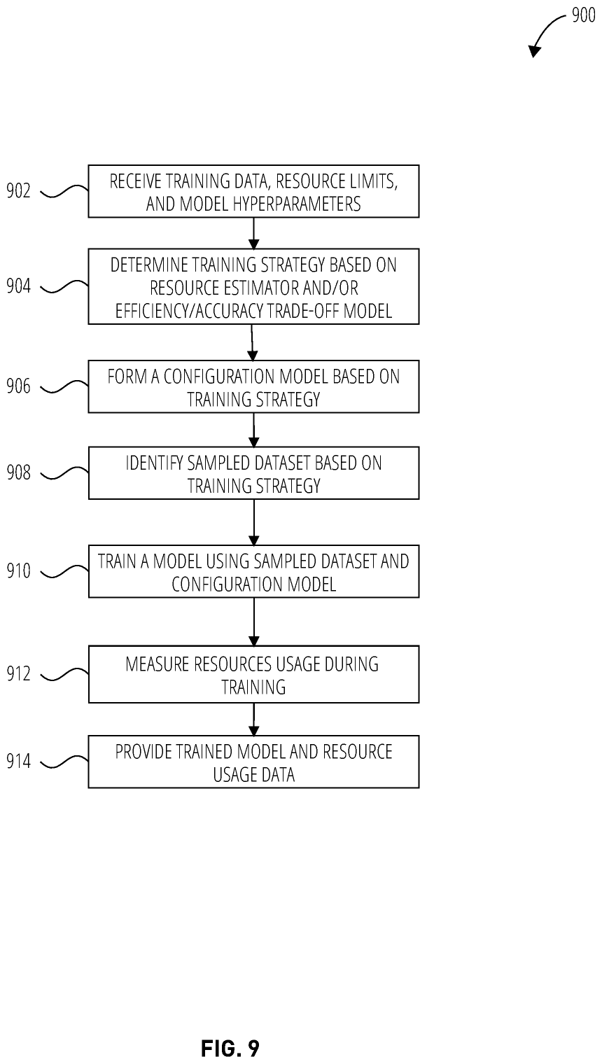

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 9, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 106 may be embodied within the network environment 100. Furthermore, some Components or functions of the network environment 100 may be combined or located elsewhere in the network environment 100. For example, some of the functions of the client device 106 may be embodied at the application server 116.

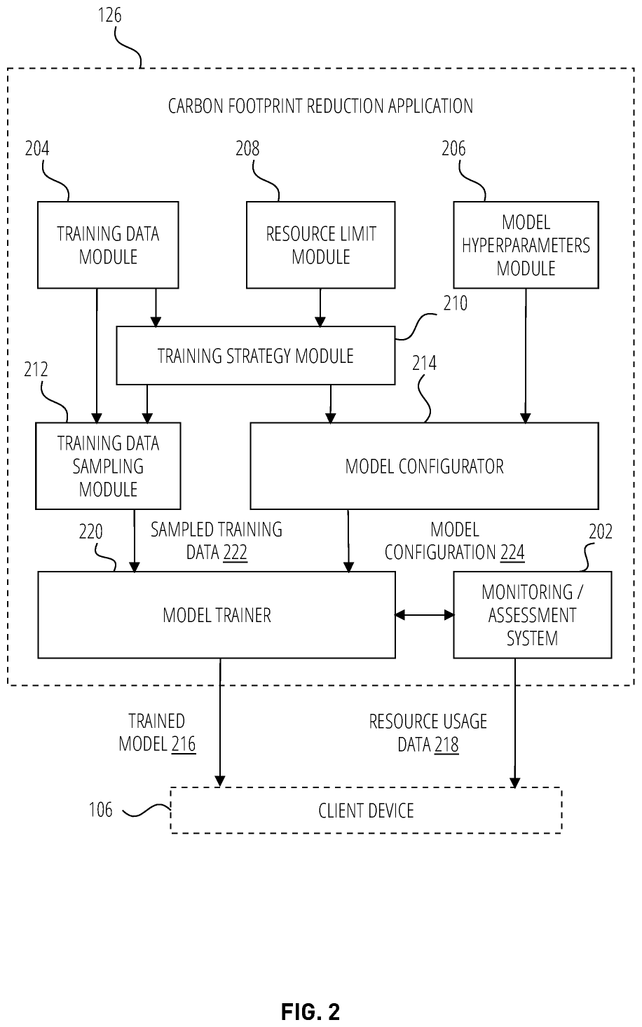

FIG. 2 illustrates a carbon footprint reduction application 126 in accordance with one example embodiment. The carbon footprint reduction application 126 includes a monitoring/assessment system 202, a training data module 204, a model hyperparameters module 206, a resource limit module 208, a training strategy module 210, a training data sampling module 212, a model configurator 214, a trained model 216, a resource usage data 218, a model trainer 220, a sampled training data 222, and a model configuration 224.

The training data module 204 acquires training data provided by the client device 106. In another example, the training data module 204 accesses training data stored in databases 128.

The resource limit module 208 receives indications of resource limits provided by the client device 106. The resource limits indicates a user-set limit on computing resources used to train a machine learning model. Examples of computing resources limits include component resources, and other types of constraints (e.g., cost of energy is typically cheaper at night when the model can be retrained, market rate of cloud compute varies).

The model hyperparameters module 206 receives model hyperparameters provided by the client device 106. Examples of model hyper parameters include convergence thresholds.

The training strategy module 210 determines a training strategy using a resource estimator (not shown) and/or an efficiency/accuracy trade-off model (not shown).

The training data sampling module 212 selects how much training data from the training data module 204 to use based on the training strategy of the training strategy module 210. the training data sampling module 212 provides the sampled training data 222 to the model trainer 220.

The model configurator 214 creates and configures an underlying model (e.g., convergence thresholds) based on the training strategy of the training strategy module 210. The model configurator 214 provides the model configuration 224 to the model trainer 220.

The model trainer 220 uses a machine learning algorithm to train a machine learning model based on the sampled training data 222 and the model configuration 224.

The monitoring/assessment system 202 measures resource usage data 218 (e.g., actual computing resources such as time and peak memory used during training). In one example embodiment, the monitoring/assessment system 202 tests and assesses a performance of the machine learning model. For example, the monitoring/assessment system 202 runs tests and benchmarks on a model to assess its algorithmic and computational performance and facilitate comparison with other models. In another example, the monitoring/assessment system 202 may receive validation of the quality or performance from a user of the client device 106. In yet another example, the monitoring/assessment system 202 includes tracking model usage, monitoring performance, and allowing the model to make predictions and take actions based on arbitrary triggers rather than simply API calls from other services.

The carbon footprint reduction application 126 provides the trained model 216 and the resource usage data 218 to the client device 106.

The following illustrates an example operation of the carbon footprint reduction application 126: Data scientist (Daniela) needs to quickly identify when a car crash has happened, using telemetry data, so they can quickly contact customers involved in the crash. Ultimately the model needs to run on the box that is located in the car. There are a lot of data available to train a model. Daniela hands the problem to another data scientist (Daisy), along with a deadline to see a preliminary result next week.

Daisy builds a sequence of candidate models to test out different ideas. Daisy constructs a candidate solution using Components from a library. Examples of libraries include machine learning algorithm library, and resource monitoring library.

With respect to the machine learning algorithm library, the user can incorporate these algorithms into their custom solutions. These algorithms can also be trained within the user-specified resource constraints. The library can include algorithms to support a diverse selection of machine learning problems (e.g. classification, regression, clustering, anomaly detection), using a diverse range of data types (e.g. numeric, categorical, text, and image).

With respect to the resource monitoring library, the user can use this library to measure the resources that they are interested in (e.g. measuring only the memory and time required during model training). In one example, the library supports (1) measuring time taken to execute a block of code, and (2) peak memory used while executing a block of code.

Returning back to the user flow example, Daisy wants to do a quick test to see if the solution is a good candidate. Daisy uses to the training strategy module 210 and the model configurator 214 to downsample the data and/or tweak the model hyperparameters/convergence thresholds to run quickly. Daisy uses the model trainer 220 to train the models and analyzes the results.

Daisy repeats this process many times. She selects the best model that solves the problem, trains it using more resources (e.g. more data, better hyperparameters, tighter convergence tolerance), and provides the analysis and model to Daniela.

Daniela assesses the results and asks Daisy for further improvements over the output, to be delivered within a week. Daisy goes back to try one or two more ideas to find a potential improved model and decides to spend most of her time by launching big (and computationally expensive) experiments, even though she doesn't know what scale of improvement to expect. Daisy reports her new results to Daniela. Daniela estimates that the improved results will not actually add much value to the business, so decides to keep the model implemented one week ago. Daniela has to report the outcome of the project to the executive team.

Alternative embodiments of quantifying the costs and benefits of different techniques for optimizing for efficiency versus accuracy include:
Benchmarking different machine learning algorithms and models on sample datasets to quantify their resource usage (computation time, memory, energy). This could identify the most efficient algorithms.
Testing different training sample sizes and measuring impact on model accuracy and resource usage. This could help develop guidelines for minimum viable sample sizes.
Evaluating different model optimization techniques like reducing features or convergence thresholds and measuring impact on accuracy and resource usage.
Deploying trained models on different hardware configurations and measuring inference time, memory usage, and energy consumption. This could guide optimization of deployment configurations.
Monitoring resource usage during model retraining/transfer learning and identifying optimization opportunities.
Gathering data on real-world model performance over time and correlating any degradation with increases in resource usage.
Comparing carbon emissions of training and deploying models in different geographical locations and with different energy sources.
Profiling resource usage of different components of the system (data preprocessing, model training, monitoring etc) to identify optimization targets.
Interviewing data scientists on their current challenges optimizing and monitoring resource use for models.

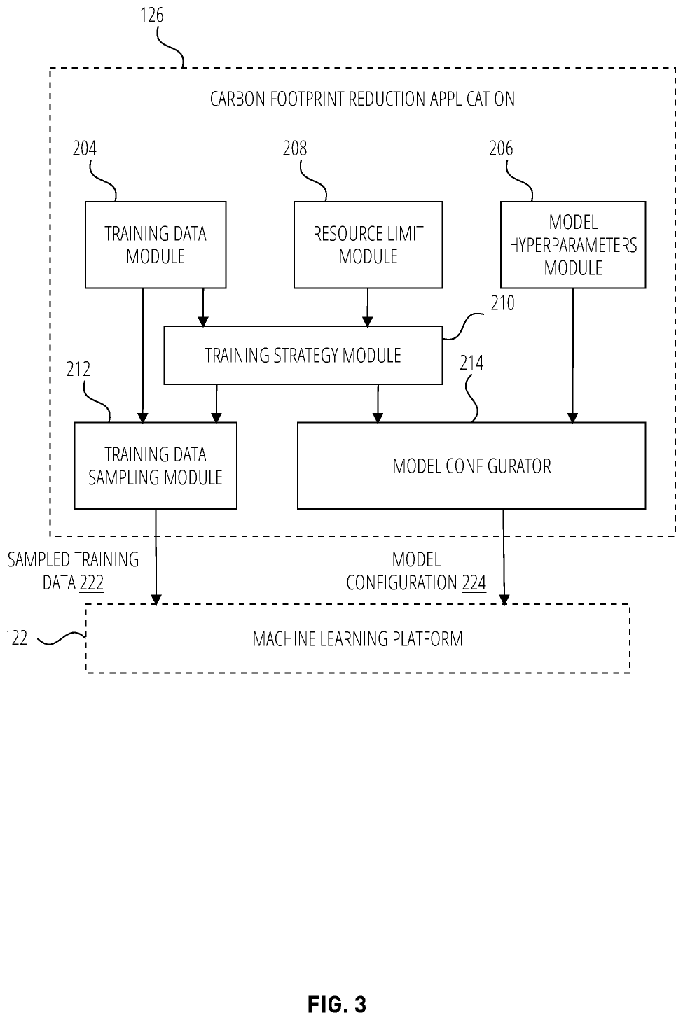

FIG. 3 illustrates a carbon footprint reduction application in accordance with one example embodiment. The carbon footprint reduction application 126 includes the training data module 204, the model hyper-parameters module 206, the resource limit module 208, the training strategy module 210, the training data sampling module 212, the model configurator 214, the sampled training data 222, and the model configuration 224.

The training data sampling module 212 selects how much training data from the training data module 204 to use based on the training strategy of the training strategy module 210. the training data sampling module 212 provides the sampled training data 222 to the machine learning platform 122.

The model configurator 214 creates and configures an underlying model (e.g., convergence thresholds) based on the training strategy of the training strategy module 210. The model configurator 214 provides the model configuration 224 to the machine learning platform 122.

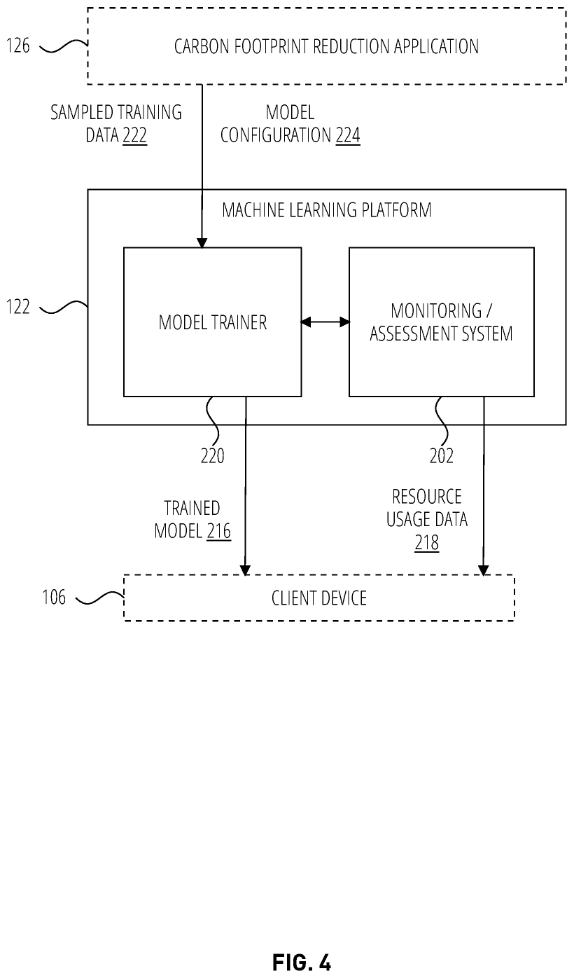

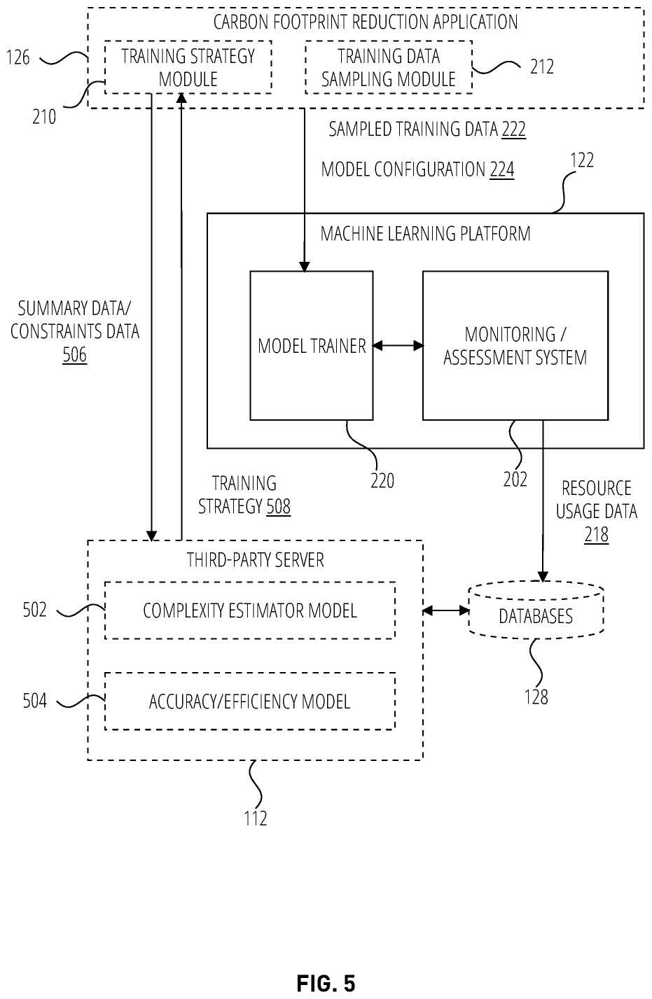

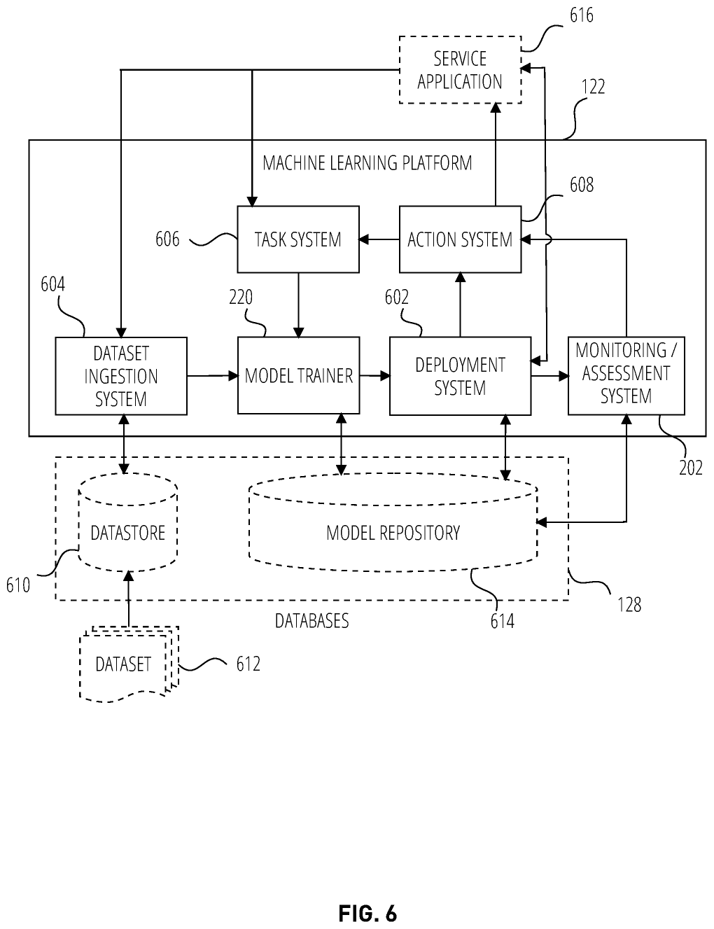

In the example of FIG. 3, the machine learning platform 122 is a separate Component that is not part of the carbon footprint reduction application 126. In one example, the machine learning platform 122 can operate at the application server 116 or on third-party server 112. The machine learning platform 122 uses a machine learning algorithm to train a machine learning model based on the sampled training data 222 and the model configuration 224. The machine learning platform 122 provides the trained model 216 and the resource usage data 218 to the client device 106. An example of the machine learning platform 122 is described in more detail below with respect to FIG. 4, FIG. 5, and FIG. 6.

FIG. 4 illustrates a machine learning platform 122 in accordance with one example embodiment. The machine learning platform 122 includes a model trainer 220, a monitoring/assessment system 202.

The model trainer 220 receives sampled training data 222 and model configuration 224 from the carbon footprint reduction application 126. In one example embodiment, the model trainer 220 annotates the sampled training data 222 with statistical properties (e.g., mean, variance, n-ordered differences) and tags (e.g., parts of speech for words in the text data, days of week for date-time values, anomaly flagging for continuous data). In another example embodiment, the model trainer 220 analyzes the sampled training data 222 and determines whether additional training data (relevant or complimentary to the training data) are available to further augment the training data. In another example, the model trainer 220 requests the client device 106 to provide additional data. In another example, the model trainer 220 accesses a library of datasets in the databases 128 and augments the sampled training data 222 with at least one of the dataset from the library of datasets. In yet another example, the sampled training data 222 accesses a marketplace of datasets (e.g., provided by the third-party application 114) to identify a dataset to augment the training data. For example, a data set includes a column of zip codes. The model trainer 220 identifies the data as zip codes and offers to augment the data set by adding another dataset such as “mean income” for each zip code from a library of other datasets (e.g., latitude, longitude, elevation, weather factors, social factor).

In another example embodiment, the model trainer 220 includes an advisor feature that advises the client device 106 on how to prepare the sampled training data 222 for processing by the model trainer 220. For example, the model trainer 220 analyzes a structure of the sampled training data 222 and notifies the carbon footprint reduction application 126 that the dataset contains missing values that should be replaced or amended before processing by the model trainer 220. In one example, the carbon footprint reduction application 126 or the model trainer 220 estimates the missing values of the sampled training data 222 based on approximation.

The model trainer 220 uses a machine learning algorithm to train a machine learning model (e.g., trained model 216) based on the sampled training data 222 and the model configuration 224 provided by the carbon footprint reduction application 126. The model configuration 224 indicates a training strategy.

Some examples of training strategies include:

Early stopping—Stop training once model performance on a validation set stops improving, instead of training for the maximum number of epochs. This can reduce training time while maintaining accuracy.

Hyperparameter tuning—Tune model hyperparameters like learning rate, batch size, and layer sizes to find the simplest model that meets accuracy targets. More complex models require more computation.

Data reduction—Use a subset of the full training data based on statistical sampling techniques. Training on less data can significantly reduce resource usage.

Mixed precision—Use a mix of lower and higher precision numerical formats in the model calculations to reduce memory footprint and increase compute speed.

Knowledge distillation—Train a smaller “student” model to mimic the outputs of a large “teacher” model to compress knowledge into a lighter-weight model.

Pruning—Remove redundant or non-salient parts of a neural network like filters or connections. Can reduce model size without much accuracy loss.

Efficient architectures—Use more efficient model architectures like MobileNets and EfficientNets that are designed specifically for resource-constrained environments.

Quantization—Convert model weights and activations from floating point to integer representations requiring less bits.

Caching—Cache parts of datasets and model layers to reduce disk reads and memory copies.

The model configuration 224 would analyze the tradeoffs and select a combination of these strategies to maximize efficiency while meeting the user's accuracy targets. The exact strategies would depend on the specific model, data, and hardware environment.

The monitoring/assessment system 202 monitors and measures actual resources (e.g., resource usage data 218) used by the model trainer 220 during training. Examples of resource usage data 218 include time and peak memory usage. In another example, the monitoring/assessment system 202 monitors the deployment of the machine learning model. For example, the monitoring/assessment system 202 continuously monitors a performance of the machine learning model and provides a feedback to the client device 106 and/or the carbon footprint reduction application 126. For example, the carbon footprint reduction application 126 provides (updated) sampled training data 222 and (updated) model configuration 224 to the model trainer 220. This process may be referred to as meta learning. In another example, the monitoring/assessment system 202 may also monitor characteristics of the sampled training data 222 such as frequency of missing values or outliers, and employ different strategies to remedy these issues. The monitoring/assessment system 202 thus provides feedback to the carbon footprint reduction application 126 and/or client device 106 to refine strategies to use for a given situation by learning which strategy is most effective.

In one example embodiment, the monitoring/assessment system 202 monitors a performance of the machine learning model. For example, the monitoring/assessment system 202 intermittently assesses the performance of the machine learning model as new data comes in, such that an updated score can be derived representing the model's most recent performance. In another example, the monitoring/assessment system 202 quantifies and monitors the sensitivity of the machine learning model to noise by perturbing the data and assessing the impact on model scores/predictions. After updating a machine learning model, the monitoring/assessment system 202 may also test the machine learning model on a set of holdout data to ensure it is appropriate for deployment (e.g., by comparing the performance of a new model to the performance of previous models). Model performance can also be quantified in terms of compute time and required resources such that if the frequency or type of data being ingested changes causing a drop in efficiency or speed, the user may be alerted to this.

The monitoring/assessment system 202 determines whether the performance/accuracy of the machine learning model is acceptable (e.g., above a threshold score). If the monitoring/assessment system 202 determines that the performance/accuracy of the machine learning model is no longer acceptable, the monitoring/assessment system 202 directs the carbon footprint reduction application 126 to revise the training strategy of the training strategy module 210. For example, if performance is no longer acceptable, the monitoring/assessment system 202 alerts the user 130 through communication means (e.g., email/text), and provides suggestions of the cause of the problem and remedial steps.

The model trainer 220 provides the trained model 216 to the client device 106. The monitoring/assessment system 202 provides the resource usage data 218 to the client device 106.

FIG. 5 illustrates how the carbon footprint reduction application 126 interacts with external components to continuously improve its training strategy.

The carbon footprint reduction application 126 contains the training strategy module 210. This provides summary data and constraints 506 to external third party servers 112. The third party servers 112 contain two models-a complexity estimator model 502 and an accuracy/efficiency model 504. The complexity estimator model 502 estimates the computational resource usage required to train a machine learning model, based on characteristics of the model itself. The accuracy/efficiency model 504 evaluates the tradeoff between model accuracy and computational efficiency.

These two models receive the summary data and constraints from the carbon footprint reduction application 126. They also access the resource usage data 218 stored in the databases 128. This resource usage data contains metrics on the actual resources consumed during previous training runs. Using the summary data constraints and the historic resource usage data, the two models generate an updated training strategy 508. This is provided back to the carbon footprint reduction application 126.

By continuously updating the training strategy using external models trained on actual resource usage data, the system can improve over time at selecting efficient configurations that minimize resource usage and carbon footprint.

FIG. 6 illustrates a machine learning platform 122 in accordance with one example embodiment. The machine learning platform 122 includes a dataset ingestion system 604, a model trainer 220, a deployment system 602, a monitoring/assessment system 202, a task system 606, an action system 608.

The dataset ingestion system 604 acquires training data for the model trainer 220 from a datastore 610 at the databases 128. The datastore 610 includes a dataset provided by the client device 106, the service application 616, or the third-party application 114. In one example embodiment, the dataset ingestion system 604 annotates the training data with statistical properties (e.g., mean, variance, n-ordered differences) and tags (e.g., parts of speech for words in the text data, days of week for date-time values, anomaly flagging for continuous data). In another example embodiment, the dataset ingestion system 604 analyzes the training data and determines whether additional training data (relevant or complimentary to the training data) are available to further augment the training data. In one example, the dataset ingestion system 604 requests the client device 106 to provide additional data. In another example, the dataset ingestion system 604 accesses a library of datasets in the datastore 610 and augments the training data with at least one of the dataset from the library of datasets. In yet another example, the dataset ingestion system 604 accesses a marketplace of datasets (e.g., provided by the third-party application 114) to identify a dataset to augment the training data. For example, a data set includes a column of zip codes. The dataset ingestion system 604 identifies the data as zip codes and offers to augment the data set by adding another dataset such as “mean income” for each zip code from a library of other datasets (e.g., latitude, longitude, elevation, weather factors, social factor).

In another example embodiment, the dataset ingestion system 604 includes an advisor feature that advises the client device 106 (that provides the dataset 612) on how to prepare the dataset 612 for processing by the model trainer 220. For example, the dataset ingestion system 604 analyzes a structure of the dataset 612 and advises the client device 106 that the dataset contains missing values that should be amended before processing by the model trainer 220. In one example, the dataset ingestion system 604 estimates the missing values based on approximation.

The task system 606 defines a task for the model trainer 220. For example, the task identifies parameters of a goal (e.g., problem to be solved, target column, data validation and testing method, scoring metric). The task system 606 receives a definition of the task from the client device 106, the service application 616, or the third-party application 114. In another example, the task system 606 receives an updated task from the action system 608. The task system 606 can also define non-machine learning tasks, such as data transformations and analysis.

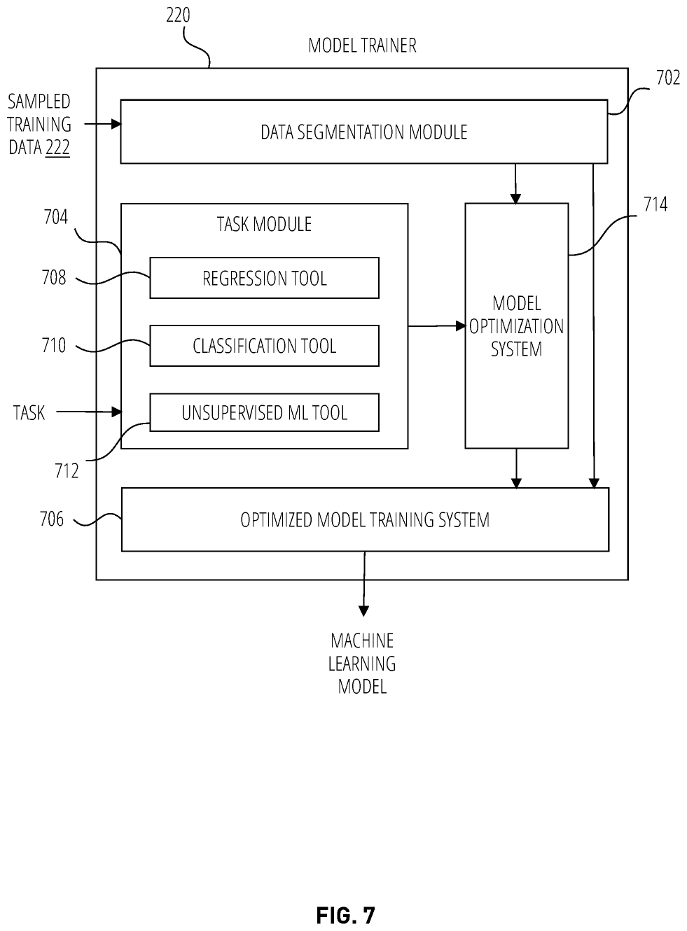

The model trainer 220 uses a machine learning algorithm to train a machine learning model based on the data from the dataset ingestion system 604 and the task from the task system 606. In one example, the model trainer 220 forms and optimizes a machine learning model to solve the task defined in the task system 606. Example embodiments of the model trainer 220 are described further below with respect to FIG. 7.

The deployment system 602 includes a deployment engine (not shown) that deploys the machine learning model to other applications (that are external to the machine learning platform 122). For example, the deployment system 602 provisions an infrastructure such that the machine learning model may exist in a query-able setting and be used to make predictions upon request. An example of a deployment includes uploading of the machine learning model or parameters to replicate such a model to the deployment system 602, such that the deployment system 602 may then support the machine learning model and expose the relevant functionalities.

In another example, the deployment system 602 enables the service application 616 to access and use the machine learning model to generate forecasts and predictions on new data. The deployment system 602 stores the model in a model repository 614 of the databases 128.

The monitoring/assessment system 202 tests and assesses a performance of the machine learning model (from the deployment system 602). For example, the monitoring/assessment system 202 runs tests and benchmarks on a model to assess its algorithmic and computational performance and facilitate comparison with other models. In another example, the monitoring/assessment system 202 may receive validation of the quality or performance from a user of the client device 106. In yet another example, the monitoring/assessment system 202 includes tracking model usage, monitoring performance, and allowing the model to make predictions and take actions based on arbitrary triggers rather than simply API calls from other services.

In another example, the deployment system 602 enables the service application 616 to access and use the machine learning model to generate forecasts and predictions on new data. In another example, the deployment system 602 stores the model in a model repository 614 of the databases 128.

The action system 608 triggers an external action (e.g., a call to the service application 616) based predefined conditions. For example, the action system 608 detects that the deployment system 602 has deployed the machine learning model. In response to detecting the deployment of the machine learning model, the action system 608 notifies the service application 616 (e.g., by generating and communicating an alert of the deployment to the service application 616). Other examples of actions from the action system 608 include retraining of the machine learning model, updating of model parameters, stopping the model functioning if performance is below a threshold (failsafe feature), communicating (via email/text/messaging platform) alerts based on performance or usage.

The monitoring/assessment system 202 monitors the deployment of the machine learning model. For example, the monitoring/assessment system 202 continuously monitors a performance of the machine learning model (used by the service application 616) and provides a feedback to the dataset ingestion system 604 and the task system 606 via the action system 608. For example, the service application 616 provides an updated task to the task system 606 and latest data to the dataset ingestion system 604. This process may be referred to as meta learning. In another example, the monitoring/assessment system 202 may also monitor characteristics of the data such as frequency of missing values or outliers, and employ different strategies to remedy these issues. The monitoring/assessment system 202 thus refines which strategies to use for a given situation by learning which strategy is most effective.

In one example embodiment, the monitoring/assessment system 202 monitors a performance of the machine learning model. For example, the monitoring/assessment system 202 intermittently assesses the performance of the machine learning model as new data comes in, such that an updated score can be derived representing the model's most recent performance. In another example, the monitoring/assessment system 202 quantifies and monitors the sensitivity of the machine learning model to noise by perturbing the data and assessing the impact on model scores/predictions. After updating a machine learning model, the monitoring/assessment system 202 may also test the machine learning model on a set of holdout data to ensure it is appropriate for deployment (e.g., by comparing the performance of a new model to the performance of previous models). Model performance can also be quantified in terms of compute time and required resources such that if the frequency or type of data being ingested changes causing a drop in efficiency or speed, the user may be alerted to this.

The monitoring/assessment system 202 determines whether the performance/accuracy of the machine learning model is acceptable (e.g., above a threshold score). If the monitoring/assessment system 202 determines that the performance/accuracy of the machine learning model is no longer acceptable, the action system 608 redefines the task at the task system 606 or suggests changes to the training data at dataset ingestion system 604. For example, if performance is no longer acceptable, the action system 608 raises an alert to the user 130 through communication means (e.g., email/text), and provide suggestions of the cause of the problem and remedial steps. The action system 608 can also update the model based on the latest data or stop the model from making predictions. In another example embodiment, these action behaviors may be defined by the user in an “if this then that” fashion.

FIG. 7 illustrates a model trainer 220 in accordance with another example embodiment. The model trainer 220 includes a data segmentation module 702, a task module 704, a model optimization system 714, and an optimized model training system. The data segmentation module 702 receives sampled training data 222. The data segmentation module 702 summarizes the data. For example, data is summarized by calculating summary statistics and describing the sample's distribution. Continuous values are binned and counted. Outliers and anomalies are flagged. The data segmentation module 702 further slices the summarized data into data slices such that a mathematical definition of information contained in the original data is equally distributed between the data slices. This is achieved by stratification of data partitions; ensuring that the data distributions between slices are as closely matched as possible. The data segmentation module 702 provides the data slices to the model optimization system 714.

The client device 106 provides the user-defined task to task module 704. The task module 704 includes different types of machine learning tools: a regression tool 708, a classification tool 710, and an unsupervised ML tool 712. The task module 704 maps the user-defined task to the one of the machine learning tools. For example, if the user-defined task has a goal of predicting a categorical value, the task module 704 would map the task to a classification tool. A goal of predicting a continuous value would be mapped to a regression tool. If the user-defined task is to find underlying groupings within the data, it would be mapped to a clustering (unsupervised ML) tool. In one example, a look up table is defined and provides a mapping between different types of task and a type of machine learning tool.

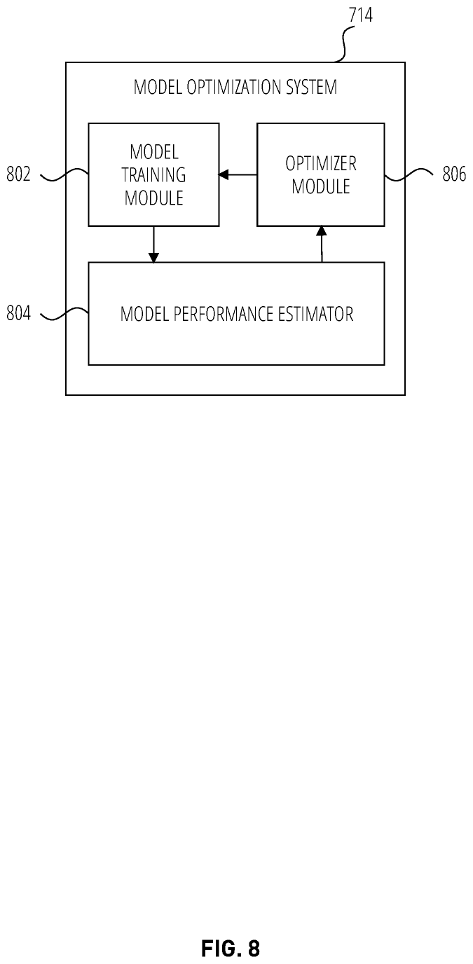

The model optimization system 714 trains a machine learning model based on the data slices and the type of machine learning tool. An example embodiment of the model optimization system 714 is described further below with respect to FIG. 8.

The optimized model training system 706 receives the optimized machine learning model from the model optimization system 714, retrains the model with all available and appropriate data, and provides the trained optimized machine learning model to the client device 106.

FIG. 8 illustrates a model optimization system in accordance with one example embodiment. The model optimization system 714 includes a model training module 802, an optimizer module 806, and a model performance estimator 804. The optimizer module 806 suggests a specific model. The specific model is defined through a set of hyper-parameters. These are a collection of named values, which together fully specify a particular model ready for model fitting on some training data.

Model training module 802 handles training of candidate machine learning models using the segmented data slices from the data segmentation module 702. For each unique hyperparameter configuration, it trains a new candidate model from scratch using the standard training procedures for that type of model.

Model performance estimator 804 evaluates the performance of each trained candidate model. It calculates one or more metrics such as accuracy, AUC, R-squared, etc on held-out validation data that was excluded from the training process. These performance metrics allow comparing different candidate models.

The optimizer module 806 receives the score and suggests another specific model based on the score. Given a model as, for example, a random forest, the model is trained using multiple data sets. The performance can be computed using, as an example, a loss function. If the score is below a threshold, the optimizer module 806 will navigate the space of hyper-parameters following, as an example, the gradients of the loss function. A new set of values for the model hyper-parameters will be suggested.

The model training module 802, model performance estimator 804, and optimizer module 806 creates an iterative loop where models are trained, evaluated, and then used to inform the selection of the next round of candidates. The model optimization system 714 converges once it finds a candidate model that achieves the highest performance score out of all configurations evaluated. The model optimization system 714 uses several criteria to determine when it has converged on the optimal model configuration:

Performance plateau—The system will track the performance metric (e.g. accuracy) achieved by the best candidate model over multiple optimization iterations. When the performance stops improving significantly between iterations despite trying new configurations, this suggests the system has converged.

Hyperparameter stability—The system will monitor the values of the hyperparameters in the best candidate model. When these values stabilize and stop changing much between iterations, it suggests convergence as the optimizer is no longer finding better areas of the search space.

Iteration limit—As a safeguard, the user can define a maximum number of optimization iterations. If this limit is reached, the system will stop and return the best model found so far.

Time limit—The user can set a maximum time budget for the optimization process. Once the allocated time is reached, the system will terminate optimization and return the current best model.

Performance threshold—The user can specify a target performance metric value to reach. Once a candidate model achieves this threshold, the system will stop optimization and return it.

Early stopping—The system can monitor performance on a holdout validation set. If performance on the holdout set starts decreasing, it suggests overfitting and the system can terminate optimization early.

As such, the model optimization system 714 uses metrics like performance plateaus, hyperparameter stability, iteration and time limits, and early stopping to determine when an optimal and generalizable model configuration has been found. The user can configure several convergence criteria to ensure the system stops at the right time.

The optimized model with the best-performing hyperparameter configuration is then passed along to the optimized model training system 706. This system retrains the model on all available training data (not just segments) before delivering the final optimized machine learning model to the user.

FIG. 9 illustrates a method for deploying a machine learning model in accordance with one example embodiment. The method 900 may be performed by one or more computational devices, as described below.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

FIG. 9 provides an overview of the key stages involved in training and deploying a machine learning model using the carbon footprint reduction application 126 and machine learning platform 122. The process begins in block 902 where the carbon footprint reduction application 126 accesses the training data from module 204, resource limits from module 208, and model hyperparameters from module 206. Next, in block 904, the training strategy module 210 determines an optimal training strategy. This takes into account estimates of the model complexity from the complexity estimator model 502 and the efficiency vs accuracy tradeoffs from the accuracy/efficiency model 504. In block 906, the model configurator 214 uses this training strategy to select appropriate configuration settings for the machine learning model, such as convergence thresholds. In block 908, the training data sampling module 212 analyzes the training strategy to select a subset of the full training data that will be sufficient but not wasteful. The model trainer 220 then performs the actual model training in block 910 using the sampled training data and configured model hyperparameters. While training, in block 912 the monitoring/assessment system 202 tracks detailed resource consumption metrics like training time and peak memory usage. After training completes, in block 914 the trained model 216 is provided to the client device 106 for deployment. The resource usage data 218 is also provided to the client and stored in databases 128 for future analysis.

This full closed-loop process allows the carbon footprint reduction application 126 to continuously enhance the efficiency of model training over time as more usage data is collected and the estimator models are retrained. The key stages of strategy optimization, data sampling, model configuration, training, and monitoring work together to minimize resource waste.

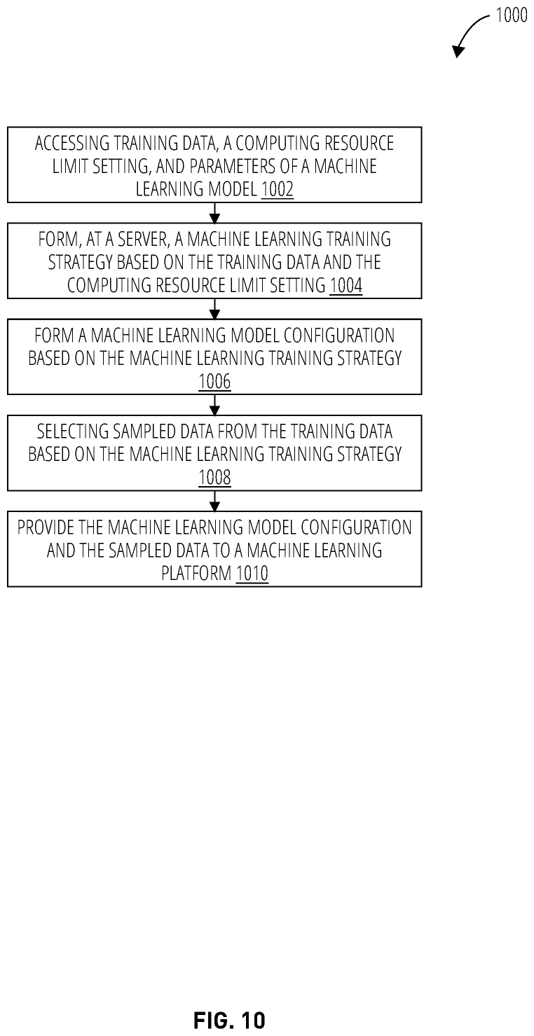

FIG. 10 illustrates a routine 1000 in accordance with one embodiment. In block 1002, routine 1000 accessing training data, a computing resource limit setting, and parameters of a machine learning model. In block 1004, routine 1000 forms, at a server, a machine learning training strategy based on the training data and the computing resource limit setting. In block 1006, routine 1000 forms a machine learning model configuration based on the machine learning training strategy. In block 1008, routine 1000 selecting sampled data from the training data based on the machine learning training strategy. In block 1010, routine 1000 provides the machine learning model configuration and the sampled data to a machine learning platform.

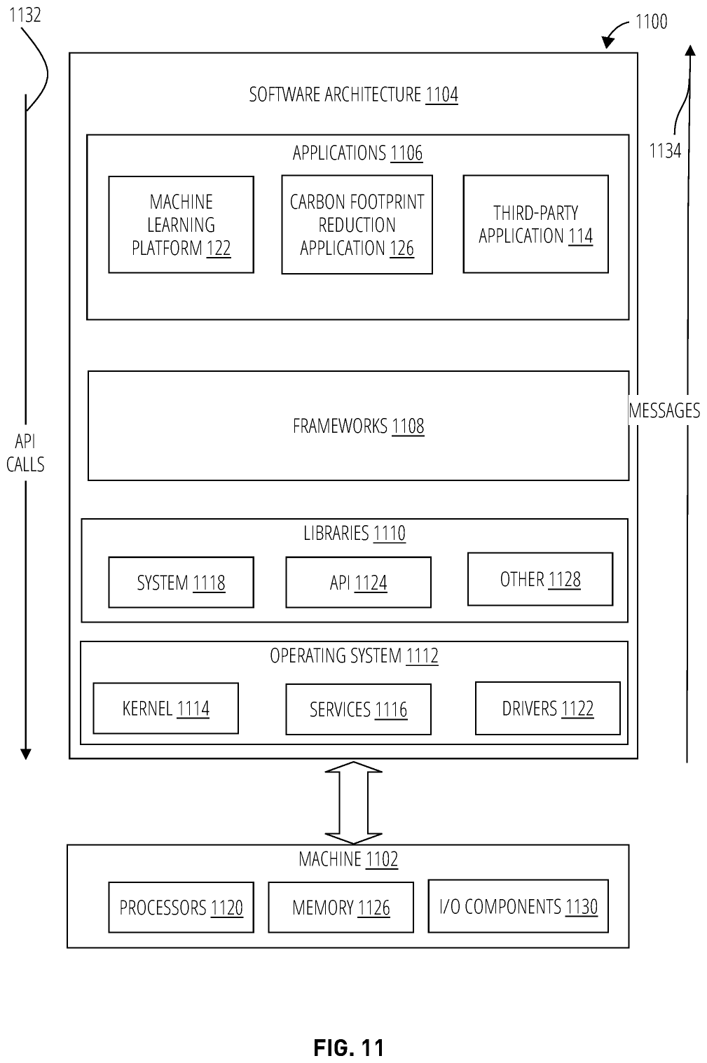

FIG. 11 is a block diagram 1100 illustrating a software architecture 1104, which can be installed on any one or more of the devices described herein. The software architecture 1104 is supported by hardware such as a machine 1102 that includes Processors 1120, memory 1126, and I/O Components 1130. In this example, the software architecture 1104 can be conceptualized as a stack of layers, where each layer provides a particular functionality. The software architecture 1104 includes layers such as an operating system 1112, libraries 1110, frameworks 1108, and applications 1106. Operationally, the applications 1106 invoke API calls 1132 through the software stack and receive messages 1134 in response to the API calls 1132.

The operating system 1112 manages hardware resources and provides common services. The operating system 1112 includes, for example, a kernel 1114, services 1116, and drivers 1122. The kernel 1114 acts as an abstraction layer between the hardware and the other software layers. For example, the kernel 1114 provides memory management, Processor management (e.g., scheduling), Component management, networking, and security settings, among other functionality. The services 1116 can provide other common services for the other software layers. The drivers 1122 are responsible for controlling or interfacing with the underlying hardware. For instance, the drivers 1122 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1110 provide a low-level common infrastructure used by the applications 1106. The libraries 1110 can include system libraries 1118 (e.g., C standard library) that provide functions such as memory allocation functions, string manipulation functions, mathematic functions, and the like. In addition, the libraries 1110 can include API libraries 1124 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1110 can also include a wide variety of other libraries 1128 to provide many other APIs to the applications 1106.

The frameworks 1108 provide a high-level common infrastructure that is used by the applications 1106. For example, the frameworks 1108 provide various graphical user interface (GUI) functions, high-level resource management, and high-level location services. The frameworks 1108 can provide a broad spectrum of other APIs that can be used by the applications 1106, some of which may be specific to a particular operating system or platform.

In an example embodiment, the applications 1106 may include a machine learning platform 122, A carbon footprint reduction application 126, and a broad assortment of other applications such as a third-party application 114. The applications 1106 are programs that execute functions defined in the programs. Various programming languages can be employed to create one or more of the applications 1106, structured in a variety of manners, such as object-oriented programming languages (e.g., Objective-C, Java, or C++) or procedural programming languages (e.g., C or assembly language). In a specific example, the third-party application 114 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 114 can invoke the API calls 1132 provided by the operating system 1112 to facilitate functionality described herein.

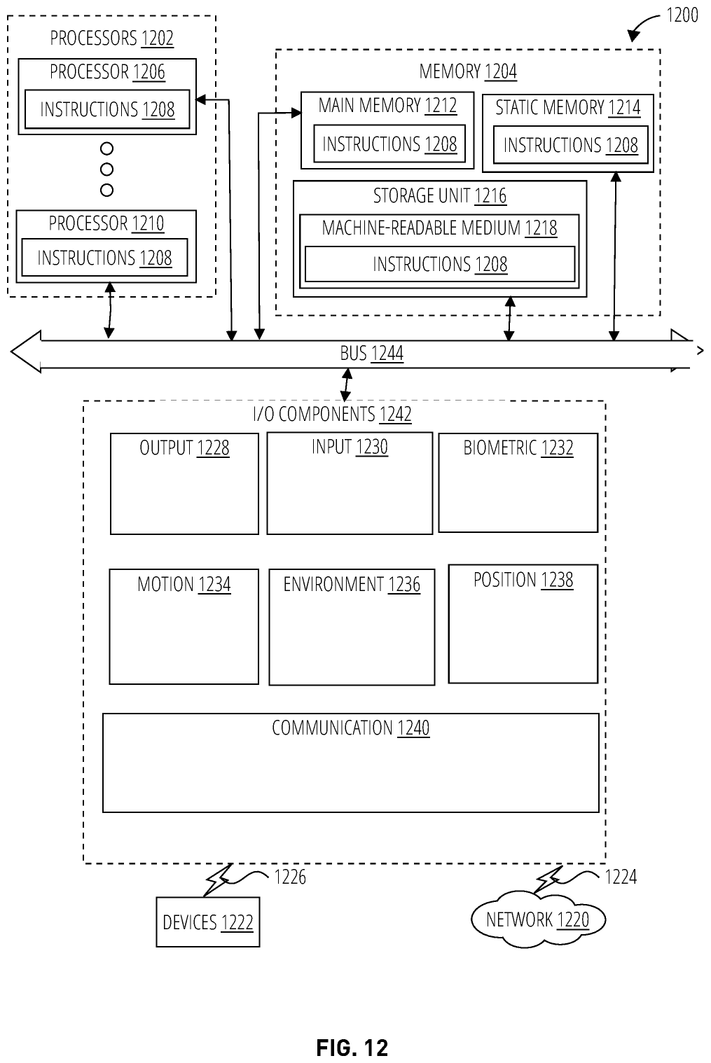

FIG. 12 is a diagrammatic representation of the machine 1200 within which instructions 1208 (e.g., software, a program, an application, an applet, an app, or other executable code) for causing the machine 1200 to perform any one or more of the methodologies discussed herein may be executed. For example, the instructions 1208 may cause the machine 1200 to execute any one or more of the methods described herein. The instructions 1208 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1208, sequentially or otherwise, that specify actions to be taken by the machine 1200. Further, while only a single machine 1200 is illustrated, the term “machine” shall also be taken to include a collection of machines that individually or jointly execute the instructions 1208 to perform any one or more of the methodologies discussed herein.

The machine 1200 may include Processors 1202, memory 1204, and I/O Components 1242, which may be configured to communicate with each other via a bus 1244. In an example embodiment, the Processors 1202 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 1206 and a Processor 1210 that execute the instructions 1208. The term “Processor” is intended to include multi-core Processors that may comprise two or more independent Processors (sometimes referred to as “cores”) that may execute instructions contemporaneously. Although FIG. 12 shows multiple Processors 1202, the machine 1200 may include a single Processor with a single core, a single Processor with multiple cores (e.g., a multi-core Processor), multiple Processors with a single core, multiple Processors with multiples cores, or any combination thereof.

The memory 1204 includes a main memory 1212, a static memory 1214, and a storage unit 1216, both accessible to the Processors 1202 via the bus 1244. The main memory 1204, the static memory 1214, and storage unit 1216 store the instructions 1208 embodying any one or more of the methodologies or functions described herein. The instructions 1208 may also reside, completely or partially, within the main memory 1212, within the static memory 1214, within machine-readable medium 1218 within the storage unit 1216, within at least one of the Processors 1202 (e.g., within the Processor's cache memory), or any suitable combination thereof, during execution thereof by the machine 1200.

The I/O Components 1242 may include a wide variety of Components to receive input, provide output, produce output, transmit information, exchange information, capture measurements, and so on. The specific I/O Components 1242 that are included in a particular machine will depend on the type of machine. For example, portable machines such as mobile phones may include a touch input device or other such input mechanisms, while a headless server machine will likely not include such a touch input device. It will be appreciated that the I/O Components 1242 may include many other Components that are not shown in FIG. 12. In various example embodiments, the I/O Components 1242 may include output Components 1228 and input Components 1230. The output Components 1228 may include visual Components (e.g., a display such as a plasma display panel (PDP), a light emitting diode (LED) display, a liquid crystal display (LCD), a projector, or a cathode ray tube (CRT)), acoustic Components (e.g., speakers), haptic Components (e.g., a vibratory motor, resistance mechanisms), other signal generators, and so forth. The input Components 1230 may include alphanumeric input Components (e.g., a keyboard, a touch screen configured to receive alphanumeric input, a photo-optical keyboard, or other alphanumeric input Components), point-based input Components (e.g., a mouse, a touchpad, a trackball, a joystick, a motion sensor, or another pointing instrument), tactile input Components (e.g., a physical button, a touch screen that provides location and/or force of touches or touch gestures, or other tactile input Components), audio input Components (e.g., a microphone), and the like.

In further example embodiments, the I/O Components 1242 may include biometric Components 1232, motion Components 1234, environmental Components 1236, or position Components 1238, among a wide array of other Components. For example, the biometric Components 1232 include Components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 1234 include acceleration sensor Components (e.g., accelerometer), gravitation sensor Components, rotation sensor Components (e.g., gyroscope), and so forth. The environmental Components 1236 include, for example, illumination sensor Components (e.g., photometer), temperature sensor Components (e.g., one or more thermometers that detect ambient temperature), humidity sensor Components, pressure sensor Components (e.g., barometer), acoustic sensor Components (e.g., one or more microphones that detect background noise), proximity sensor Components (e.g., infrared sensors that detect nearby objects), gas sensors (e.g., gas detection sensors to detection concentrations of hazardous gases for safety or to measure pollutants in the atmosphere), or other Components that may provide indications, measurements, or signals corresponding to a surrounding physical environment. The position Components 1238 include location sensor Components (e.g., a GPS receiver Component), altitude sensor Components (e.g., altimeters or barometers that detect air pressure from which altitude may be derived), orientation sensor Components (e.g., magnetometers), and the like.

Communication may be implemented using a wide variety of technologies. The I/O Components 1242 further include communication Components 1240 operable to couple the machine 1200 to a network 1220 or devices 1222 via a coupling 1224 and a coupling 1226, respectively. For example, the communication Components 1240 may include a network interface Component or another suitable device to interface with the network 1220. In further examples, the communication Components 1240 may include wired communication Components, wireless communication Components, cellular communication Components, Near Field Communication (NFC) Components, Bluetooth® Components (e.g., Bluetooth® Low Energy), Wi-Fi® Components, and other communication Components to provide communication via other modalities. The devices 1222 may be another machine or any of a wide variety of peripheral devices (e.g., a peripheral device coupled via a USB).

Moreover, the communication Components 1240 may detect identifiers or include Components operable to detect identifiers. For example, the communication Components 1240 may include Radio Frequency Identification (RFID) tag reader Components, NFC smart tag detection Components, optical reader Components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection Components (e.g., microphones to identify tagged audio signals). In addition, a variety of information may be derived via the communication Components 1240, such as location via Internet Protocol (IP) geolocation, location via Wi-Fi® signal triangulation, location via detecting an NFC beacon signal that may indicate a particular location, and so forth.

The various memories (e.g., memory 1204, main memory 1212, static memory 1214, and/or memory of the Processors 1202) and/or storage unit 1216 may store one or more sets of instructions and data structures (e.g., software) embodying or used by any one or more of the methodologies or functions described herein. These instructions (e.g., the instructions 1208), when executed by Processors 1202, cause various operations to implement the disclosed embodiments.

The instructions 1208 may be transmitted or received over the network 1220, using a transmission medium, via a network interface device (e.g., a network interface Component included in the communication Components 1240) and using any one of a number of well-known transfer protocols (e.g., hypertext transfer protocol (HTTP)). Similarly, the instructions 1208 may be transmitted or received using a transmission medium via the coupling 1226 (e.g., a peer-to-peer coupling) to the devices 1222.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Example 1 is a computer-implemented method comprising: accessing training data, a computing resource limit setting, and parameters of a machine learning model; forming, at a server, a machine learning training strategy based on the training data and the computing resource limit setting; forming a machine learning model configuration based on the machine learning training strategy; selecting sampled data from the training data based on the machine learning training strategy; and providing the machine learning model configuration and the sampled data to a machine learning platform.

In Example 2, the subject matter of Example 1 includes, training, using the machine learning platform at the server, the machine learning model with the sampled data and the machine learning model configuration, an output of training of the machine learning model comprising a trained machine learning model; and monitoring computing resources of the machine learning platform during training of the machine learning model, an output of monitoring computing resources comprising resource usage data.

In Example 3, the subject matter of Example 2 includes, generating an updated machine learning model configuration recommendation based on the resource usage data.

In Example 4, the subject matter of Examples 2-3 includes, receiving, from a client device, the training data, the computing resource limit setting, and parameters of the machine learning model; and providing the resource usage data and the trained machine learning model to the client device.

In Example 5, the subject matter of Examples 2-4 includes, wherein the resource usage data indicate a time length and peak memory used during the training of the machine learning model.

In Example 6, the subject matter of Examples 2-5 includes, wherein forming the machine learning training strategy comprises: providing a summary of the training data and the computing resource limit setting to a resource estimator and an efficiency accuracy trade-off modeler; and receiving the machine learning training strategy from the resource estimator and the efficiency accuracy trade-off modeler, wherein the resource estimator is configured to estimate a complexity of the machine learning model based on the summary of the training data, wherein the efficiency accuracy trade-off modeler is configured to model a trade-off between an efficiency of the machine learning model and an accuracy of the machine learning model.

In Example 7, the subject matter of Example 6 includes, providing the resource usage data and the machine learning training strategy to the resource estimator and the efficiency accuracy trade-off modeler, wherein the resource estimator and the efficiency accuracy trade-off modeler are configured to generate an updated machine learning training strategy; forming an updated machine learning model configuration based on the updated machine learning training strategy; and providing the updated machine learning model configuration and the sampled data to the machine learning platform.

In Example 8, the subject matter of Examples 1-7 includes, testing a deployed machine learning model based on the machine learning model configuration; accessing a performance assessment of the deployed machine learning model; and generating a performance indicator of the deployed machine learning model based on the testing and the performance assessment; determining that the performance indicator of the deployed machine learning model transgresses a deployed machine learning model performance threshold; in response to determining that the performance indicator of the deployed machine learning model transgresses the deployed machine learning model performance threshold, updating the deployed machine learning model, wherein updating the deployed machine learning model further comprises: updating the machine learning training strategy and the sampled data based on the performance indicator of the machine learning model.

In Example 9, the subject matter of Examples 1-8 includes, wherein the machine learning platform is operated on a second server, the second server being configured to: train, using the machine learning platform, the machine learning model with the sampled data and the machine learning model configuration, an output of training the machine learning model comprising a trained machine learning model; monitor computing resources of the machine learning platform during training of the machine learning model on the second server, an output of monitoring the computing resources comprising resource usage data; and provide the resource usage data and the trained machine learning model to a client device.

In Example 10, the subject matter of Examples 1-9 includes, wherein the machine learning training strategy comprises one of a random forest classifier or a gaussian process regressor.

Example 11 is a computing apparatus comprising: a Processor; and a memory storing instructions that, when executed by the Processor, configure the apparatus to: access training data, a computing resource limit setting, and parameters of a machine learning model; form, at a server, a machine learning training strategy based on the training data and the computing resource limit setting; form a machine learning model configuration based on the machine learning training strategy; select sampled data from the training data based on the machine learning training strategy; and provide the machine learning model configuration and the sampled data to a machine learning platform.

In Example 12, the subject matter of Example 11 includes, wherein the instructions further configure the apparatus to: train, using the machine learning platform at the server, the machine learning model with the sampled data and the machine learning model configuration, an output of training of the machine learning model comprising a trained machine learning model; and monitor computing resources of the machine learning platform during training of the machine learning model, an output of monitoring computing resources comprising resource usage data.

In Example 13, the subject matter of Example 12 includes, wherein the instructions further configure the apparatus to: generate an updated machine learning model configuration recommendation based on the resource usage data.

In Example 14, the subject matter of Examples 12-13 includes, wherein the instructions further configure the apparatus to: receive, from a client device, the training data, the computing resource limit setting, and parameters of the machine learning model; and provide the resource usage data and the trained machine learning model to the client device.

In Example 15, the subject matter of Examples 12-14 includes, wherein the resource usage data indicate a time length and peak memory used during the training of the machine learning model.

In Example 16, the subject matter of Examples 12-15 includes, wherein forming the machine learn training strategy comprises: provide a summary of the training data and the computing resource limit setting to a resource estimator and an efficiency accuracy trade-off modeler; and receive the machine learning training strategy from the resource estimator and the efficiency accuracy trade-off modeler, wherein the resource estimator is configured to estimate a complexity of the machine learning model based on the summary of the training data, wherein the efficiency accuracy trade-off modeler is configured to model a trade-off between an efficiency of the machine learn model and an accuracy of the machine learning model.

In Example 17, the subject matter of Example 16 includes, wherein the instructions further configure the apparatus to: provide the resource usage data and the machine learning training strategy to the resource estimator and the efficiency accuracy trade-off modeler, wherein the resource estimator and the efficiency accuracy trade-off modeler are configured to generate an updated machine learning training strategy; form an updated machine learning model configuration based on the updated machine learning training strategy; and provide the updated machine learning model configuration and the sampled data to the machine learning platform.

In Example 18, the subject matter of Examples 11-17 includes, test a deployed machine learning model based on the machine learning model configuration; access a performance assessment of the deployed machine learning model; and generate a performance indicator of the deployed machine learning model based on the testing and the performance assessment; determine that the performance indicator of the deployed machine learning model transgresses a deployed machine learning model performance threshold; in response to determining that the performance indicator of the deployed machine learning model transgresses the deployed machine learning model performance threshold, updating the deployed machine learning model, wherein updating the deployed machine learning model further comprises: update the machine learning training strategy and the sampled data based on the performance indicator of the machine learning model.

In Example 19, the subject matter of Examples 11-18 includes, wherein the machine learning platform is operated on a second server, the second server being configured to: train, using the machine learning platform, the machine learning model with the sampled data and the machine learning model configuration, an output of training the machine learning model comprising a trained machine learning model; monitor computing resources of the machine learning platform during training of the machine learning model on the second server, an output of monitoring the computing resources comprising resource usage data; and provide the resource usage data and the trained machine learning model to a client device.

Example 20 is a non-transitory computer-readable storage medium, the computer-readable storage medium including instructions that when executed by a computer, cause the computer to: access training data, a computing resource limit setting, and parameters of a machine learning model; form, at a server, a machine learning training strategy based on the training data and the computing resource limit setting; form a machine learning model configuration based on the machine learning training strategy; select sampled data from the training data based on the machine learning training strategy; and provide the machine learning model configuration and the sampled data to a machine learning platform.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A computer-implemented method comprising:
accessing training data, a computing resource limit setting, and parameters of a machine learning model;
forming, at a server, a machine learning training strategy based on the training data and the computing resource limit setting;
forming a machine learning model configuration based on the machine learning training strategy;
selecting sampled data from the training data based on the machine learning training strategy; and
providing the machine learning model configuration and the sampled data to a machine learning platform.

2. The computer-implemented method of claim 1, further comprising:
training, using the machine learning platform at the server, the machine learning model with the sampled data and the machine learning model configuration, an output of training of the machine learning model comprising a trained machine learning model; and
monitoring computing resources of the machine learning platform during training of the machine learning model, an output of monitoring computing resources comprising resource usage data.

3. The computer-implemented method of claim 2, further comprising:
generating an updated machine learning model configuration recommendation based on the resource usage data.

4. The computer-implemented method of claim 2, further comprising:
receiving, from a client device, the training data, the computing resource limit setting, and parameters of the machine learning model; and
providing the resource usage data and the trained machine learning model to the client device.

5. The computer-implemented method of claim 2, wherein the resource usage data indicate a time length and peak memory used during the training of the machine learning model.

6. The computer-implemented method of claim 2, wherein forming the machine learning training strategy comprises:
providing a summary of the training data and the computing resource limit setting to a resource estimator and an efficiency accuracy trade-off modeler; and
receiving the machine learning training strategy from the resource estimator and the efficiency accuracy trade-off modeler,
wherein the resource estimator is configured to estimate a complexity of the machine learning model based on the summary of the training data,
wherein the efficiency accuracy trade-off modeler is configured to model a trade-off between an efficiency of the machine learning model and an accuracy of the machine learning model.

7. The computer-implemented method of claim 6, further comprising:
providing the resource usage data and the machine learning training strategy to the resource estimator and the efficiency accuracy trade-off modeler, wherein the resource estimator and the efficiency accuracy trade-off modeler are configured to generate an updated machine learning training strategy;
forming an updated machine learning model configuration based on the updated machine learning training strategy; and
providing the updated machine learning model configuration and the sampled data to the machine learning platform.

8. The computer-implemented method of claim 1, further comprises:
testing a deployed machine learning model based on the machine learning model configuration;
accessing a performance assessment of the deployed machine learning model; and
generating a performance indicator of the deployed machine learning model based on the testing and the performance assessment;
determining that the performance indicator of the deployed machine learning model transgresses a deployed machine learning model performance threshold;
in response to determining that the performance indicator of the deployed machine learning model transgresses the deployed machine learning model performance threshold, updating the deployed machine learning model,
wherein updating the deployed machine learning model further comprises:
updating the machine learning training strategy and the sampled data based on the performance indicator of the machine learning model.

9. The computer-implemented method of claim 1, wherein the machine learning platform is operated on a second server, the second server being configured to:
train, using the machine learning platform, the machine learning model with the sampled data and the machine learning model configuration, an output of training the machine learning model comprising a trained machine learning model;
monitor computing resources of the machine learning platform during training of the machine learning model on the second server, an output of monitoring the computing resources comprising resource usage data; and
provide the resource usage data and the trained machine learning model to a client device.

10. The computer-implemented method of claim 1, wherein the machine learning training strategy comprises one of a random forest classifier or a gaussian process regressor.

11. A computing apparatus comprising:
a processor; and
a memory storing instructions that, when executed by the processor, configure the apparatus to:
access training data, a computing resource limit setting, and parameters of a machine learning model;
form, at a server, a machine learning training strategy based on the training data and the computing resource limit setting;
form a machine learning model configuration based on the machine learning training strategy;
select sampled data from the training data based on the machine learning training strategy; and
provide the machine learning model configuration and the sampled data to a machine learning platform.

12. The computing apparatus of claim 11, wherein the instructions further configure the apparatus to:
train, using the machine learning platform at the server, the machine learning model with the sampled data and the machine learning model configuration, an output of training of the machine learning model comprising a trained machine learning model; and
monitor computing resources of the machine learning platform during training of the machine learning model, an output of monitoring computing resources comprising resource usage data.

13. The computing apparatus of claim 12, wherein the instructions further configure the apparatus to:
generate an updated machine learning model configuration recommendation based on the resource usage data.

14. The computing apparatus of claim 12, wherein the instructions further configure the apparatus to:
receive, from a client device, the training data, the computing resource limit setting, and parameters of the machine learning model; and
provide the resource usage data and the trained machine learning model to the client device.

15. The computing apparatus of claim 12, wherein the resource usage data indicate a time length and peak memory used during the training of the machine learning model.

16. The computing apparatus of claim 12, wherein forming the machine learn training strategy comprises:
provide a summary of the training data and the computing resource limit setting to a resource estimator and an efficiency accuracy trade-off modeler; and
receive the machine learning training strategy from the resource estimator and the efficiency accuracy trade-off modeler,
wherein the resource estimator is configured to estimate a complexity of the machine learning model based on the summary of the training data,
wherein the efficiency accuracy trade-off modeler is configured to model a trade-off between an efficiency of the machine learn model and an accuracy of the machine learning model.

17. The computing apparatus of claim 16, wherein the instructions further configure the apparatus to:
provide the resource usage data and the machine learning training strategy to the resource estimator and the efficiency accuracy trade-off modeler, wherein the resource estimator and the efficiency accuracy trade-off modeler are configured to generate an updated machine learning training strategy;
form an updated machine learning model configuration based on the updated machine learning training strategy; and
provide the updated machine learning model configuration and the sampled data to the machine learning platform.

18. The computing apparatus of claim 11, further comprises:
test a deployed machine learning model based on the machine learning model configuration;
access a performance assessment of the deployed machine learning model; and
generate a performance indicator of the deployed machine learning model based on the testing and the performance assessment;
determine that the performance indicator of the deployed machine learning model transgresses a deployed machine learning model performance threshold;
in response to determining that the performance indicator of the deployed machine learning model transgresses the deployed machine learning model performance threshold, updating the deployed machine learning model,
wherein updating the deployed machine learning model further comprises:
update the machine learning training strategy and the sampled data based on the performance indicator of the machine learning model.

19. The computing apparatus of claim 11, wherein the machine learning platform is operated on a second server, the second server being configured to:
train, using the machine learning platform, the machine learning model with the sampled data and the machine learning model configuration, an output of training the machine learning model comprising a trained machine learning model;
monitor computing resources of the machine learning platform during training of the machine learning model on the second server, an output of monitoring the computing resources comprising resource usage data; and
provide the resource usage data and the trained machine learning model to a client device.

20. A non-transitory computer-readable storage medium, the computer-readable storage medium including instructions that when executed by a computer, cause the computer to:
access training data, a computing resource limit setting, and parameters of a machine learning model;
form, at a server, a machine learning training strategy based on the training data and the computing resource limit setting;
form a machine learning model configuration based on the machine learning training strategy;
select sampled data from the training data based on the machine learning training strategy; and
provide the machine learning model configuration and the sampled data to a machine learning platform.
